(19) United States
(12) Patent Application Publication
(10) Pub. No.: US 2026/0113230 A1
(43) Pub. Date: Apr. 23, 2026

(54) METHOD AND APPARATUS OF TRANSMITTING SIGNAL IN OTFS SYSTEM

(71) Applicant: ELECTRONICS AND TELECOMMUNICATIONS RESEARCH INSTITUTE, Daejeon (KR)

(72) Inventors: Kwanwoong RYU, Daejeon (KR); Kwonhue CHOI, Daegu (KR); Chung Sup KIM, Daejeon (KR); JUNSEOK KIM, Daejeon (KR); Hyuk Je KIM, Daejeon (KR); Hyung-seop SON, Daegu (KR); Sung Woong CHOI, Daejeon (KR)

(73) Assignee: ELECTRONICS AND TELECOMMUNICATIONS RESEARCH INSTITUTE, Daejeon (KR)

(21) Appl. No.: 19/348,265

(22) Filed: Oct. 2, 2025

(30) Foreign Application Priority Data
Oct. 23, 2024 (KR) 10-2024-0145974

(51) Int. Cl. H04L 27/26; H04L 5/00

(52) U.S. Cl. CPC H04L 27/2639; H04L 5/0023; H04L 27/26532

(57) ABSTRACT

In a method of transmitting a signal in an OTFS system, a delay-Doppler domain matrix is generated based on information symbols. A plurality of block data is generated by grouping elements of the delay-Doppler domain matrix. A delay-time domain matrix is generated by performing an IDFT on each of the plurality of block data. A plurality of row data is generated by grouping elements of the delay-time domain matrix. A final delay-time domain matrix is generated by interleaving each of the plurality of row data. A transmission signal is transmitted based on the final delay-time domain matrix.

### CROSS-REFERENCE TO RELATED APPLICATIONS

This application claims priority under 35 U.S.C. § 119 to Korean Patent Application No. 10-2024-0145974 filed on Oct. 23, 2024, in the Korean Intellectual Property Office, the disclosure of which is incorporated by reference herein in its entirety.

### BACKGROUND

Embodiments of the present disclosure described herein relate to a communication system, and more particularly, relate to a method and an apparatus of transmitting a signal in an orthogonal time frequency space (OTFS) system.

The Discrete Fourier Transform spread Orthogonal Frequency Division Multiplexing (DFT-s-OFDM) is a modulation scheme that reduces a Peak-to-Average Power Ratio (PAPR) using DFT precoding in conventional OFDM and has been standardized as an uplink modulation scheme of 4G LTE-A (Long Term Evolution-Advanced) and 5G NR (New Radio).

However, in high-speed mobile environments such as enhanced vehicle-to-everything (eV2X) communications, the performance of DFT-s-OFDM is limited due to Inter Channel/Carrier Interference (ICI). To overcome this, DFT-s-OTFS with OTFS modulation scheme has been proposed, which can achieve strong robustness to Doppler spread compared to OFDM and DFT-s-OFDM and can provide a lower PAPR compared to OTFS.

### SUMMARY

Embodiments of the present disclosure provide a method and an apparatus of transmitting a signal in an OTFS system, capable of providing improved performance in a high-speed moving environment for next-generation communication.

According to an embodiment of the present disclosure, in a method of transmitting a signal in an OTFS system according to an embodiment of the present disclosure, a delay-Doppler domain matrix is generated based on information symbols. A plurality of block data is generated by grouping elements of the delay-Doppler domain matrix. A delay-time domain matrix is generated by performing an Inverse Discrete Fourier Transform (IDFT) on each of the plurality of block data. A plurality of row data is generated by grouping elements of the delay-time domain matrix. A final delay-time domain matrix is generated by interleaving each of the plurality of row data. A transmission signal is transmitted based on the final delay-time domain matrix.

According to an embodiment of the present disclosure, an apparatus of transmitting a signal in an OTFS system includes a delay-Doppler domain matrix generator, a delay-time domain matrix generator, a final delay-time domain matrix generator, and a transmitter. The delay-Doppler domain matrix generator generates a delay-Doppler domain matrix based on information symbols. The delay-time domain matrix generator generates a delay-time domain matrix based on a plurality of block data obtained by grouping elements of the delay-Doppler domain matrix. The final delay-time domain matrix generator generates a final delay-time domain matrix based on a plurality of row data obtained by grouping elements of the delay-time domain matrix. The transmitter transmits a transmission signal based on the final delay-time domain matrix.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an apparatus of transmitting a signal in an OTFS system according to an embodiment of the present disclosure.

FIG. 2 is a flowchart illustrating a method of transmitting a signal in the OTFS system according to an embodiment of the present disclosure.

FIG. 3 is a diagram for describing an embodiment of the delay-Doppler domain matrix of FIG. 1.

FIG. 4 is a diagram for describing an embodiment of the delay-time domain matrix generator of FIG. 1.

FIG. 5 is a diagram for describing an embodiment of the plurality of block data of FIG. 2.

FIG. 6 is a flowchart illustrating an embodiment of the operation of generating the plurality of block data of FIG. 2.

FIG. 7 is a block diagram illustrating an embodiment of an Inverse Discrete Fourier Transform (IDFT) calculator of FIG. 4.

FIG. 8 is a diagram for describing an embodiment of the delay-time domain matrix of FIG. 2.

FIG. 9 is a flowchart illustrating an embodiment of the operation of generating the delay-time domain matrix of FIG. 2.

FIG. 10 is a block diagram illustrating an embodiment of the final delay-time domain matrix generator of FIG. 1.

FIG. 11 is a diagram for describing an embodiment of the plurality of row data of FIG. 2.

FIG. 12 is a flowchart illustrating an embodiment of the operation of generating the plurality of row data of FIG. 2.

FIG. 13 is a block diagram illustrating an embodiment of the interleaver of FIG. 10.

FIG. 14 is a diagram for describing an embodiment of the final delay-time domain matrix of FIG. 2.

FIG. 15 is a flowchart illustrating an embodiment of the operation of generating the final delay-time domain matrix of FIG. 2.

FIG. 16 is a flowchart illustrating an embodiment of an operation of interleaving the first row data of FIG. 15 to arrange the interleaved first row data in a first row of the final delay-time domain matrix.

FIG. 17A is a diagram illustrating a simulation result of LP-OTFS, a method of transmitting a signal in the OTFS system according to embodiments of the present disclosure, and FIG. 17B is a diagram illustrating a simulation result of signal transmission methods according to a comparative example of the embodiments of the present invention.

FIGS. 18 and 19 are diagrams illustrating simulation results of the LP-OTFS, the method of transmitting the signal in the OTFS system according to embodiments of the present disclosure and the signal transmission methods according to the comparative example.

### DETAILED DESCRIPTION

Hereinafter, embodiments of the present disclosure will be described in detail and clearly to such an extent that an ordinary one in the art easily implements the present disclosure.

The terms “unit”, “module”, etc. to be used below and function blocks illustrated in drawings may be implemented in the form of a software component, a hardware component, or a combination thereof. Below, to describe the technical idea of the present disclosure clearly, a description associated with identical components will be omitted.

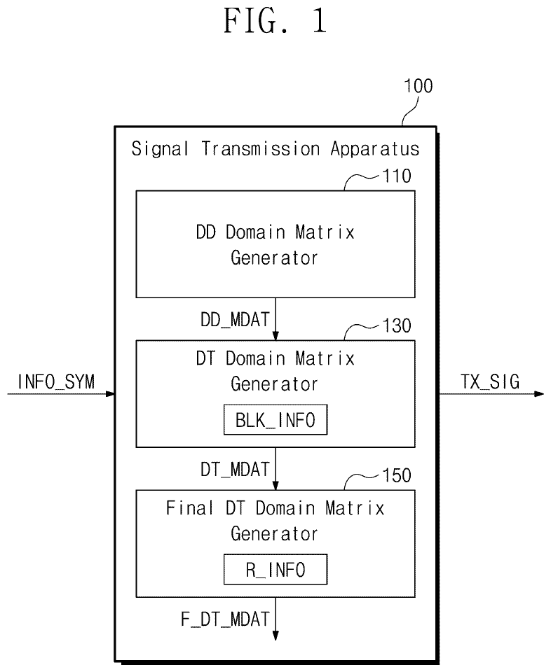

FIG. 1 is a block diagram illustrating an apparatus of transmitting a signal in an Orthogonal Time Frequency Space (OTFS) system according to an embodiment of the present disclosure.

Referring to FIG. 1, a signal transmission apparatus 100 may include a delay-Doppler (DD) domain matrix generator 110, a delay-time (DT) domain matrix generator 130, and a final delay-time domain matrix generator 150. In an embodiment, the signal transmission apparatus 100 may be a communication apparatus that transmits a transmission signal according to an OTFS modulation scheme. For example, when a transmission signal transmitted from a typical communication apparatus propagates through a wireless channel, fading may occur in a reception signal due to a surrounding environment of a transmission path. For example, the signal transmission apparatus 100 may be a communication apparatus that may be used in the Sixth Generation (6G) and next-generation communication after 6G by using the OTFS modulation scheme suitable for high-Doppler fading channels, and may provide improved performance in a high-speed moving environment.

The delay-Doppler domain matrix generator 110 may generate a delay-Doppler domain matrix DD_MDAT based on information symbols INFO_SYM, and output a delay-Doppler domain matrix DD_ MDAT.

In an embodiment, the information symbols INFO_SYM may include information to be transmitted by the signal transmission apparatus 100, may belong to a delay-Doppler domain, and the delay-Doppler domain matrix generator 110 may map the information symbols INFO_SYM to generate the delay-Doppler domain matrix DD_MDAT.

The delay-time domain matrix generator 130 may receive the delay-Doppler domain matrix DD_MDAT from the delay-Doppler domain matrix generator 110, generate a delay-time domain matrix DT_MDAT based on a plurality of block data obtained by grouping elements of the delay-Doppler domain matrix DD_ MDAT, and output a delay-time domain matrix DT_MDAT.

In an embodiment, the delay-time domain matrix generator 130 may perform a Zak Transform on the delay-Doppler domain matrix DD_MDAT to calculate the delay-time domain matrix DT_MDAT. For example, by Zak transform, the delay-time domain matrix DT_MDAT may belong to the delay-time domain. The Zak transform may have a quasi-periodic characteristic, and the delay-time domain matrix DT_MDAT may also have the quasi-periodic characteristic by the Zak transform.

The final delay-time domain matrix generator 150 may receive the delay-time domain matrix DT_MDAT from the delay-time domain matrix generator 130, generate a final delay-time domain matrix F_DT_MDAT based on a plurality of row data obtained by grouping elements of the delay-time domain matrix DT_MDAT, and output the final delay-time domain matrix F_DT_MDAT.

In an embodiment, the delay-time domain matrix generator 130 may generate a plurality of block data by grouping elements of the delay-Doppler domain matrix DD_MDAT, and may generate the delay-time domain matrix DT_MDAT by performing an Inverse Discrete Fourier Transform (IDFT) on each of the plurality of block data. The final delay-time domain matrix generator 150 may generate a plurality of row data by grouping elements of the delay-time domain matrix DT_MDAT, and may generate the final delay-time domain matrix F_DT_MDAT by interleaving each of the plurality of row data.

In an embodiment, the delay-time domain matrix generator 130 may perform IDFT on each of the plurality of block data using block information BLK_INFO, and the final delay-time domain matrix generator 150 may perform interleaving on each of the plurality of row data using row information R_INFO.

Although not shown in FIG. 1, the signal transmission apparatus 100 may further include an additional signal processor and an additional transmitter, and the signal processor and the transmitter may transmit a transmission signal TX_SIG based on the final delay-time domain matrix F_DT_MDAT.

In an embodiment, the transmitter may generate and transmit the transmission signal TX_SIG by performing a parallel-to-serial transform and a pulse shaping on the final delay-time domain matrix F_DT_MDAT. In another embodiment, the signal processor may further perform a Heisenberg transform prior to the parallel-to-serial transform by the transmitter. When the Heisenberg transform is further performed, a Fast Fourier Transform (FFT) and an Inverse Fast Fourier Transform (IFFT) may be performed on each of a plurality of column data obtained by grouping elements of the final delay-time domain matrix F_DT_MDAT. For example, in the process of performing the Heisenberg transform, a DFT (FFT) may be performed on each of the plurality of column data of the final delay-time domain matrix F_DT_MDAT along a delay axis, and an IDFT (IFFT), after the DFT is performed, may be performed along a frequency axis.

In an embodiment, an OTFS system according to embodiments of the present disclosure may perform the Zak transform or the Heisenberg transform to transmit the transmission signal TX_SIG. For example, in a scheme of performing the Heisenberg transform to transmit the transmission signal TX_SIG, all or some of data processing by the delay-time domain matrix generator 130 and the final delay-time domain matrix generator 150 may correspond to an Inverse Symplectic Finite Fourier Transform (ISFFT).

With such a configuration, a signal transmission apparatus of the OTFS system according to the embodiments of the present disclosure may perform IDFT on each of a plurality of block data obtained by grouping elements of a delay-Doppler domain matrix to generate a delay-time domain matrix, and may interleave each of the plurality of row data obtained by grouping elements of the delay-time domain matrix to generate a final delay-time domain matrix. The signal transmission apparatus may perform only IDFT on each of a plurality of block data and interleaving of each of the plurality of row data as main operations for transmitting the signal, and may significantly improve a bit error rate (BER), reduce a Peak-to-Average Power Ratio (PAPR), and significantly reduce transmission complexity.

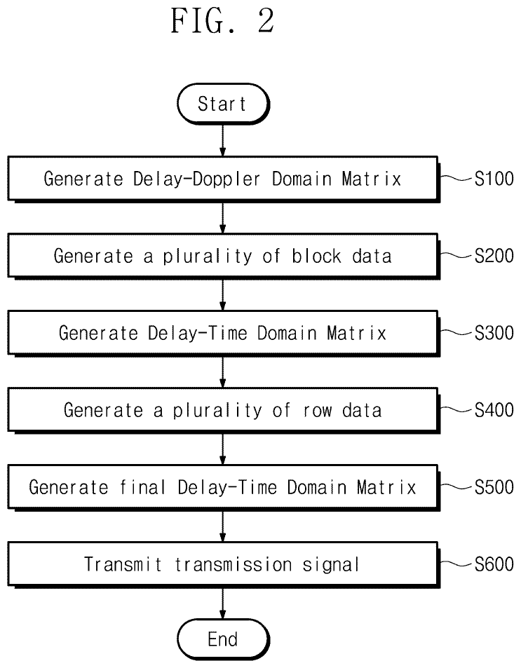

FIG. 2 is a flowchart illustrating a method of transmitting a signal in the OTFS system according to an embodiment of the present disclosure.

Referring to FIG. 2, a delay-Doppler domain matrix may be generated based on information symbols (S100).

A plurality of block data may be generated (S200).

In an embodiment, the plurality of block data may be generated by grouping elements of the delay-Doppler domain matrix.

A delay-time domain matrix may be generated (S300).

In an embodiment, the delay-time domain matrix may be generated by performing IDFT on each of the plurality of block data.

A plurality of row data may be generated (S400).

In an embodiment, the plurality of row data may be generated by grouping elements of the delay-time domain matrix.

A final delay-time domain matrix may be generated (S500).

In an embodiment, the final delay-time domain matrix may be generated by interleaving each of the plurality of row data.

A transmission signal may be transmitted (S600).

In an embodiment, the transmission signal may be generated based on the final delay-time domain matrix.

In an embodiment, S600 may include performing a Heisenberg transform.

In an embodiment, S100 may be performed by a delay-Doppler domain matrix generator (e.g., 110 of FIG. 1), S200 and S300 may be performed by delay-time domain matrix generator (e.g., 130 of FIG. 1) and S400 and S500 may be performed by a final delay-time domain matrix generator (e.g., 150 of FIG. 1).

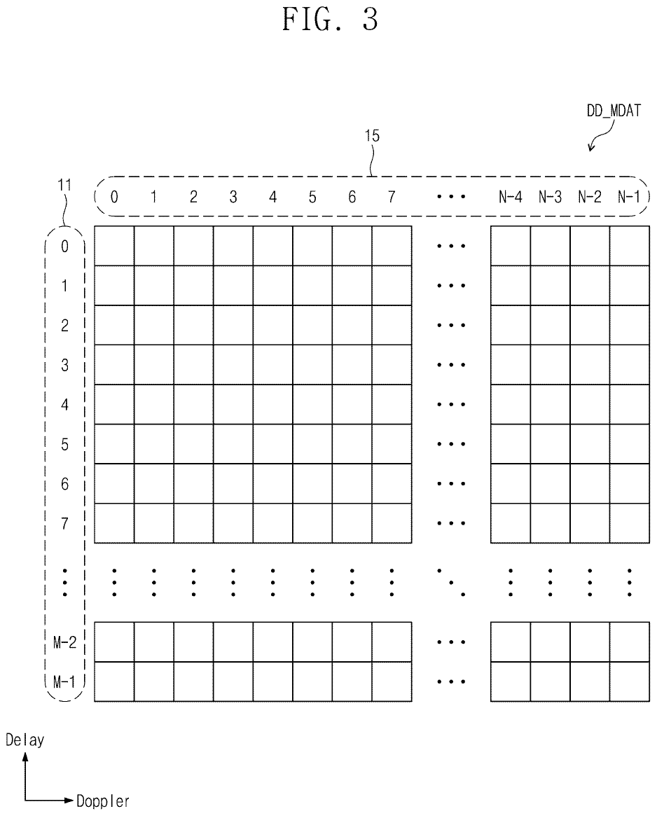

FIG. 3 is a diagram for describing an embodiment of the delay-Doppler domain matrix of FIG. 1.

Referring to FIG. 3, the delay-Doppler domain matrix DD_MDAT may be generated based on information symbols as described above with reference to FIG. 1.

In an embodiment, a size of the delay-Doppler domain matrix DD_MDAT may be M×N (M, N are an integer greater than or equal to two), and in FIG. 3, reference numeral 11 may represent indices representing a plurality of rows of the delay-Doppler domain matrix DD_MDAT, and reference numeral 15 may represent indices representing a plurality of columns of the delay-Doppler domain matrix DD_MDAT.

In an embodiment, a plurality of rows of the delay-Doppler domain matrix DD_MDAT may correspond to a delay axis of a delay-Doppler domain, and a plurality of columns of the delay-Doppler domain matrix DD_MDAT may correspond to a Doppler axis of the delay-Doppler domain.

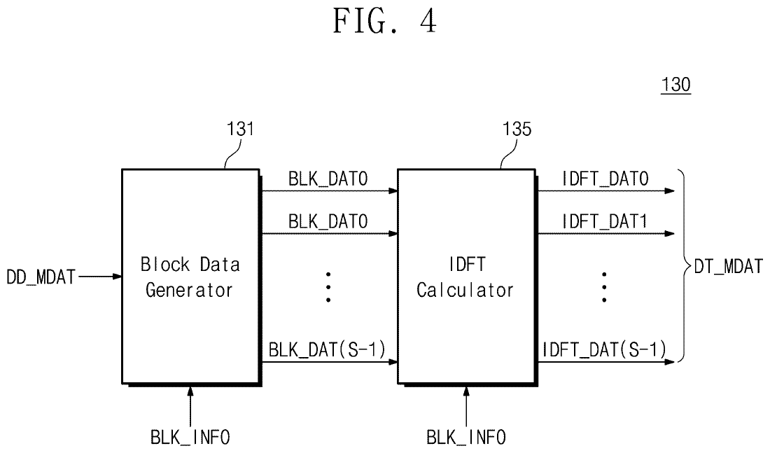

FIG. 4 is a diagram for describing an embodiment of the delay-time domain matrix generator of FIG. 1.

Referring to FIG. 4, a delay-time domain matrix generator 130 may include a block data generator 131 and an IDFT calculator 135.

The block data generator 131 may receive the delay-Doppler domain matrix DD_MDAT from the delay-Doppler domain matrix generator (e.g., 110 in FIG. 1) and generate a plurality of block data BLK_DAT0, BLK_DAT1, . . . , and BLK_DAT(S−1) based on the delay-Doppler domain matrix DD_MDAT.

In an embodiment, the block data generator 131 may generate a plurality of block data BLK_DAT0, BLK_DAT1, . . . , and BLK_DAT(S−1) based on block information BLK_INFO, and the block information BLK_INFO may represent the number (e.g., S) of the plurality of block data BLK_DAT0, BLK_DAT1, . . . , and BLK_DAT(S−1).

The IDFT calculator 135 may receive the plurality of block data BLK_DAT0, BLK_DAT1, . . . , and BLK_DAT(S−1) from the block data generator 131, and generate the plurality of IDFT data IDFT_DAT0 and IDFT_DAT1, . . . , IDFT_DAT(S−1) based on the plurality of block data BLK_DAT0, BLK_DAT1, and BLK_DAT(S−1). For example, a plurality of IDFT data IDFT_DAT0, IDFT_DAT1, . . . , and IDFT_DAT(S−1)) may be included in the delay-time domain matrix DT_MDAT (or may constitute the delay-time domain matrix DT_ MDAT) described above with reference to FIG. 1 and the like.

In an embodiment, the IDFT calculator 135 may generate a plurality of IDFT data IDFT_DAT0, IDFT_DAT1, . . . , and IDFT_DAT(S−1) based on the block information BLK, and the block information BLK_INFO may further represent a size (e.g., the number of elements arranged in one row of each block data) of each of the plurality of block data BLK_DAT0, BLK_DAT1, . . . , and BLK_DAT(S−1).

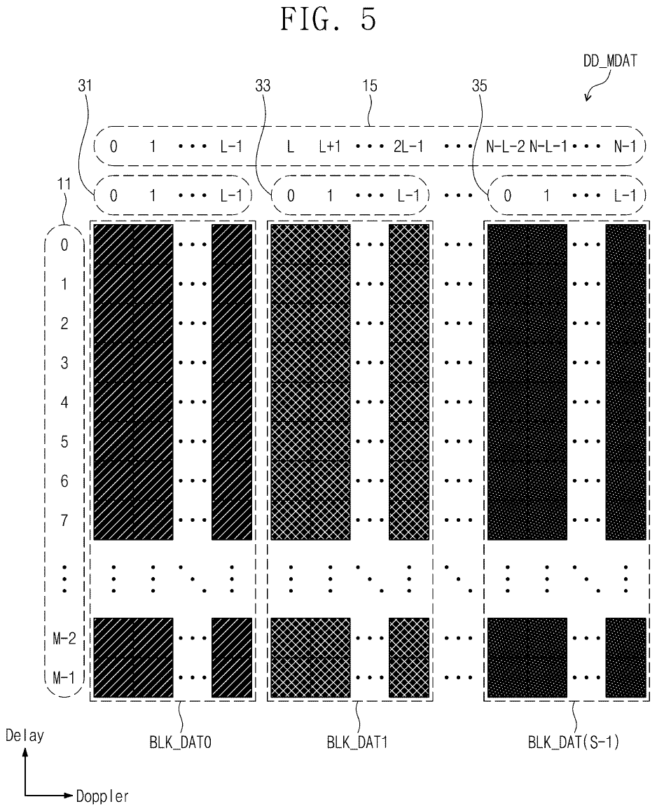

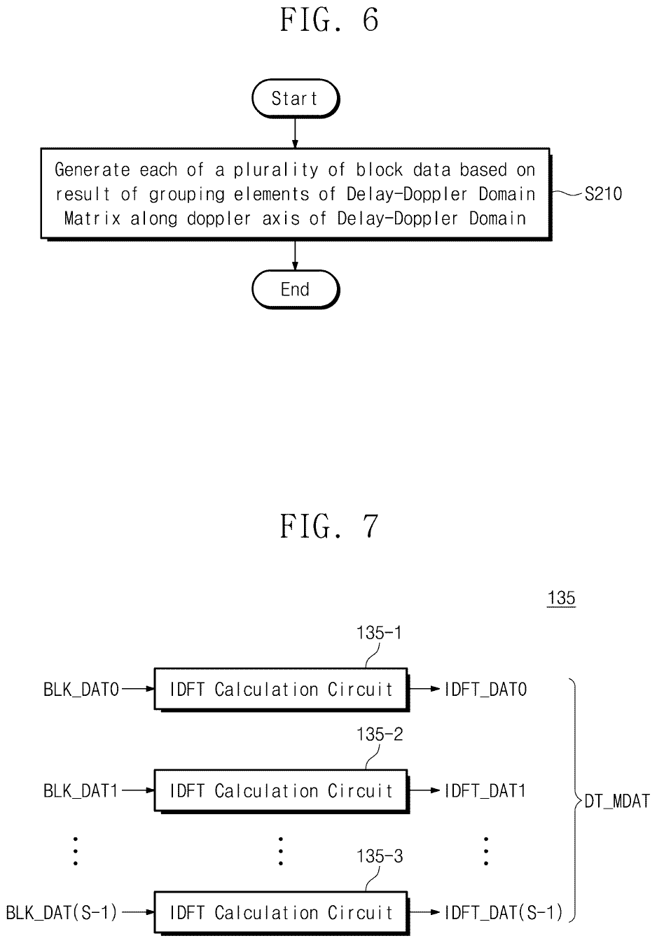

FIG. 5 is a diagram for describing an embodiment of the plurality of block data of FIG. 2. FIG. 6 is a flowchart illustrating an embodiment of the operation of generating the plurality of block data of FIG. 2.

The same reference numerals in FIGS. 3 and 5 represent the same components. Redundant descriptions will be omitted.

Referring to FIG. 5, each of a plurality of block data BLK_DAT0, BLK_DAT1, . . . , and BLK_DAT(S−1) may be generated based on a result of grouping elements of the delay-Doppler domain matrix DD_MDAT.

In an embodiment, each of the plurality of block data BLK_DAT0, BLK_DAT1, . . . , and BLK_DAT(S−1) may be generated based on a result of grouping elements of the delay-Doppler domain matrix DD_MDAT along the Doppler axis of the delay-Doppler domain.

For example, elements of the delay-Doppler domain matrix arranged in first columns 0 to L−1 among a plurality of columns 0 to N−1 (15) of the delay-Doppler domain matrix DD_MDAT may be grouped to generate the block data BLK_DAT0. Elements of the delay-Doppler domain matrix arranged in a second columns L to 2L−1 among the plurality of columns 0 to N−1 (15) of the delay-Doppler domain matrix DD_MDAT may be grouped to generate block data BLK_DAT1. Elements of the delay-Doppler domain matrix arranged in a third columns N−L to N−1 of the plurality of columns 0 to N−1 (15) of the delay-Doppler domain matrix DD_MDAT may be grouped to generate block data BLK_DAT(S−1).

In an embodiment, a size of the delay-Doppler domain matrix DD_MDAT may be M×N (M, N are an integer greater than or equal to two), and a size of each of the plurality of block data BLK_DAT0, BLK_DAT1, . . . , and BLK_DAT(S−1) may be M×L (L is an integer greater than or equal to one). Reference numerals 31, 33, 35 may be indices representing columns of respective block data. The number of the plurality of block data BLK_DAT0, BLK_DAT1, . . . , and BLK_DAT(S−1) may be S (S is an integer greater than or equal to two), the L may be less than the N, and the L may be a value obtained by dividing the N by the S.

Referring to FIGS. 5 and 6, in an operation of generating a plurality of block data BLK_DAT0, BLK_DAT1, . . . , and BLK_DAT(S−1), each of the plurality of block data BLK_DAT0, BLK_DAT1, . . . , and BLK_DAT(S−1) may be generated based on a result of grouping elements of the delay-Doppler domain matrix DD_MDAT along the Doppler axis of the delay-Doppler domain (S210).

FIG. 7 is a block diagram illustrating an embodiment of an IDFT calculator of FIG. 4.

Referring to FIG. 7, the IDFT calculator 135 may include a plurality of IDFT calculation circuits 135-1, 135-2, and 135-3.

The IDFT calculation circuit 135-1 may receive the block data BLK_DAT0 and generate the IDFT data IDFT_DAT0 by performing IDFT on the block data BLK_DAT0. The IDFT calculation circuit 135-2 may receive the block data BLK_DAT1 and generate the IDFT data IDFT_DAT1 by performing IDFT on the block data BLK_DAT1. The IDFT calculation circuit 135-3 may receive the block data BLK_DAT(S−1) and generate the IDFT data IDFT_DAT(S−1) by performing IDFT on the block data BLK_DAT(S−1).

In an embodiment, as described above with reference to FIG. 5, the size of each of the plurality of block data BLK_DAT0, BLK_DAT1, . . . , and BLK_DAT(S−1) may be M×L (L is an integer greater than or equal to one), and each of a plurality of IDFT calculation circuits 135-1, 135-2, and 135-3 may perform IDFT on elements arranged in each row of the corresponding block data. For example, each of the plurality of IDFT calculation circuits 135-1, 135-2, and 135-3 may perform an L-point IDFT corresponding to a size of elements arranged in each row of corresponding block data. The IDFT performed by each of the plurality of IDFT calculation circuits 135-1, 135-2, and 135-3 may be performed in parallel, and the IDFT data IDFT_DAT0, IDFT_DAT1, . . . , and IDFT_DAT(S−1) may be output at substantially the same time point (or within an allowable error range).

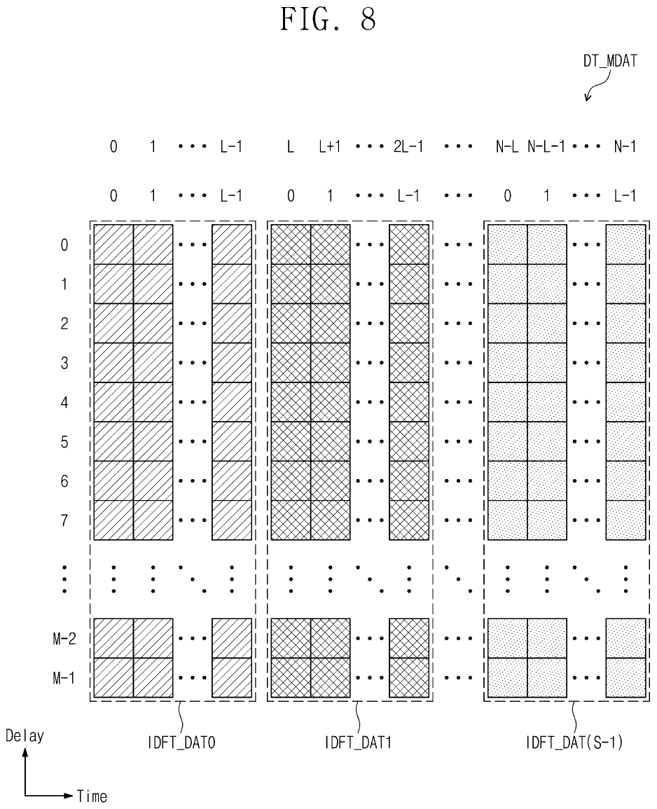

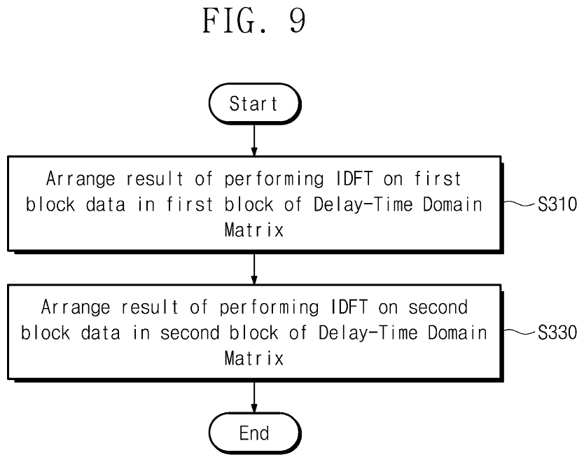

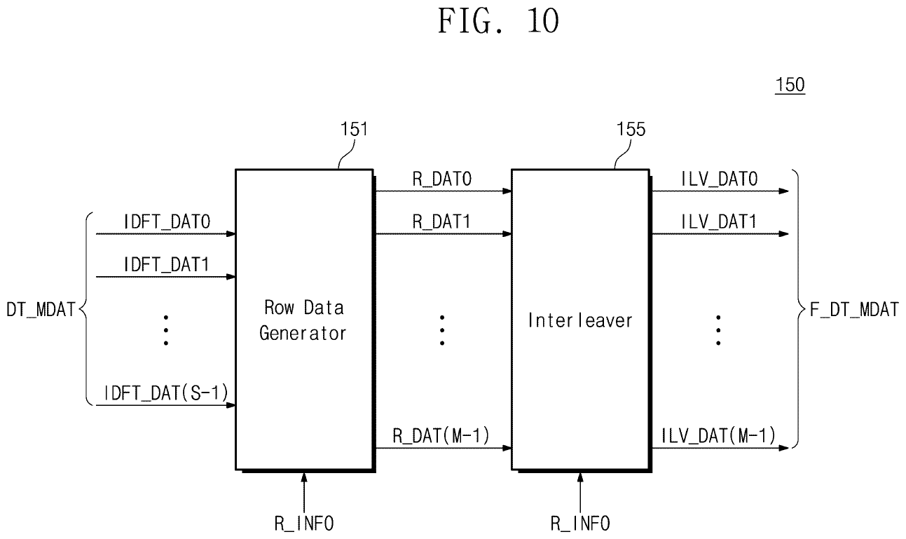

FIG. 8 is a diagram for describing an embodiment of the delay-time domain matrix of FIG. 2. FIG. 9 is a flowchart illustrating an embodiment of the operation of generating the delay-time domain matrix of FIG. 2.

Referring to FIG. 8, IDFT data IDFT_DAT0 may be arranged in a first block of a delay-time domain matrix DT_MDAT, IDFT data IDFT_DAT1 may be arranged in a second block of the delay-time domain matrix, and IDFT data IDFT_DAT(S−1) may be arranged in a third block of the delay-time domain matrix.

In an embodiment, IDFT data may be generated based on the corresponding block data, and a position where the IDFT data is arranged in the delay-time domain matrix DT_MDAT may be the same as a position where the block data corresponding to the IDFT data in the delay-Doppler domain matrix DD_MDAT is arranged. For example, a position where the IDFT data IDFT_DAT0 is arranged in the delay-time domain matrix DT_MDAT may be the same as a position where the block data BLK_DAT0 is arranged in the delay-Doppler domain matrix DD_MDAT.

Referring to FIGS. 8 and 9, in the operation of generating the delay-time domain matrix DT_MDAT, a result of performing IDFT on first block data among the plurality of block data BLK_DAT0, BLK_DAT1, . . . , and BLK_DAT(S−1) may be arranged in the first block of the delay-time domain matrix DT_ MDAT (S310), and a result of performing the IDFT on second block data among the plurality of block data BLK_DAT0, BLK_ DAT1, and BLK_DAT(S−1) may be arranged in a second block of the delay-time domain matrix DT_MDAT (S330).

FIG. 10 is a block diagram illustrating an embodiment of the final delay-time domain matrix generator of FIG. 1.

Referring to FIG. 10, the final delay-time domain matrix generator 150 may include a row data generator 151 and an interleaver 155.

The row data generator 151 may receive the delay-time domain matrix DT_MDAT from the delay-time domain matrix generator (e.g., 130 in FIG. 1) and generate a plurality of row data R_DAT0, R_DAT1, . . . , and R_DAT(M−1) based on the delay-time domain matrix DT_ MDAT.

In an embodiment, the row data generator 151 may generate a plurality of row data R_DAT0, R_DAT1, . . . , and R_DAT(M−1) based on row information R_INFO, and the row information R_INFO may represent the number (e.g., M) of the plurality of row data R_DAT0, R_DAT1 . . . , and R_DAT(M−1).

The interleaver 155 may receive a plurality of row data R_DAT0, R_DAT1, . . . , and R_DAT(M−1) from the row data generator 151, and generate a plurality of interleaved data ILV_DAT0, ILV_DAT1, . . . , and ILV_DAT(M−1) based on the plurality of row data R_DAT0, R_DAT1, . . . , and R_DAT(M−1). For example, the plurality of interleaved data ILV_DAT0, ILV_DAT1, . . . , and ILV_DAT(M−1) may be included in the final delay-time domain matrix F_DT_MDAT (or may constitute the final delay-time domain matrix F_DT_MDAT) described above with reference to FIG. 1 and the like.

In an embodiment, the interleaver 155 may generate a plurality of interleaved data ILV_DAT0, ILV_DAT1, . . . , and ILV_DAT(M−1) based on the row information R_INFO, and the row information R_INFO may further represent a size (e.g., the number of elements arranged in each interleaved data) of each of the plurality of interleaved data ILV_DAT0, ILV_DAT1, . . . , and ILV_DAT(M−1).

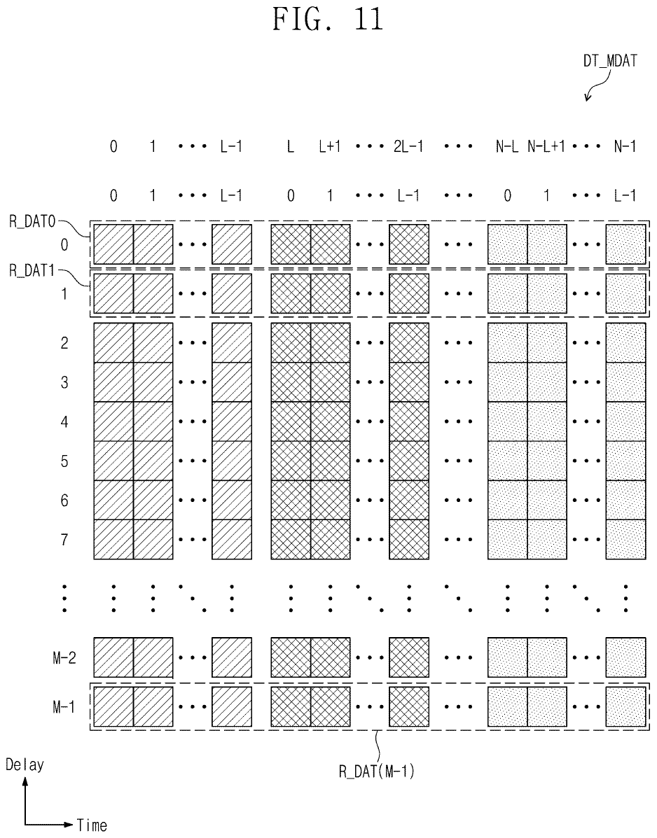

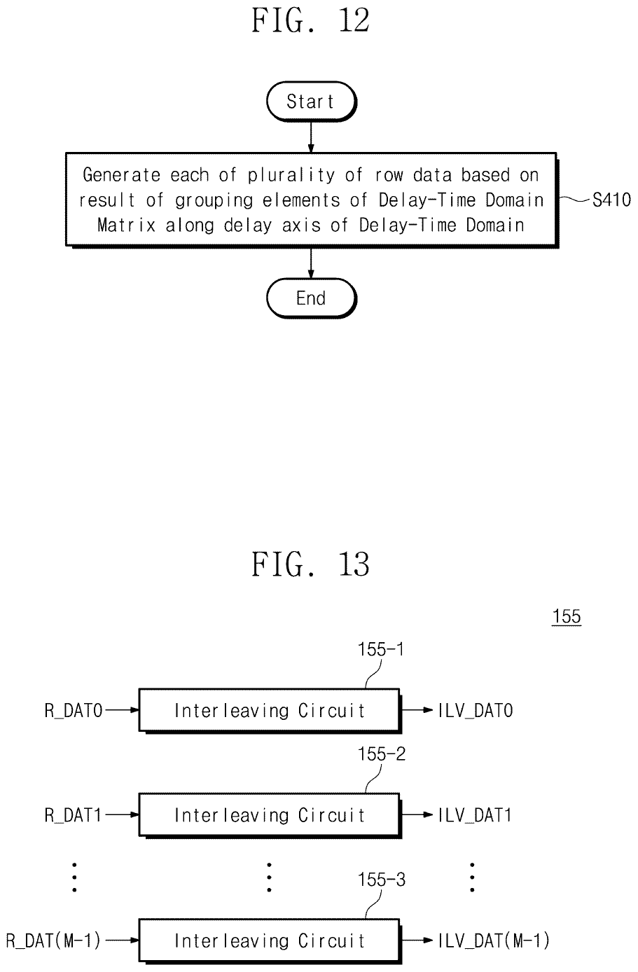

FIG. 11 is a diagram for describing an embodiment of the plurality of row data of FIG. 2. FIG. 12 is a flowchart illustrating an embodiment of the operation of generating the plurality of row data of FIG. 2.

The same reference numerals in FIGS. 5 and 11 represent the same components. Redundant descriptions will be omitted.

Referring to FIG. 11, each of a plurality of row data R_DAT0, R_DAT1, . . . , and R_DAT(M−1) may be generated based on a result of grouping elements of the delay-time domain matrix DT_MDAT.

In an embodiment, each of the plurality of row data R_DAT0, R_DAT1, . . . , and R_DAT (M−1) may be generated based on a result of grouping the elements of the delay-time domain matrix DT_MDAT along the delay axis of the delay-time domain.

For example, elements of a delay-time domain matrix arranged in a first row 0 of a plurality of rows 0, . . . , and M−1 of the delay-time domain matrix DT_MDAT may be grouped to generate row data R_DAT0. Elements of the delay-time domain matrix arranged in a second row 1 among the plurality of rows 0, . . . , and M−1 of the delay-time domain matrix DT_MDAT may be grouped to generate row data R_DAT1. Elements of the delay-time domain matrix arranged in a third row M−1 among the plurality of rows 0, . . . , and M−1of the delay-time domain matrix DT_MDAT may be grouped to generate row data R_DAT (M−1).

In an embodiment, a size of the delay-time domain matrix DT_MDAT may be M×N, and a size of each of the plurality of row data R_DAT0, R_DAT1, . . . , and R_DAT(M−1) may be 1×N. The number of the plurality of row data R_DAT0, R_DAT1, . . . , and R_DAT(M−1) may be M.

Referring to FIGS. 11 and 12, in an operation of generating the plurality of row data R_DAT0, R_DAT1, . . . , and R_DAT(M−1), each of the plurality of row data R_DAT0, R_DAT1, . . . , and R_DAT(M−1) may be generated based on a result of grouping elements of the delay-time domain matrix DT_MDAT along the delay axis of the delay-time domain (S410).

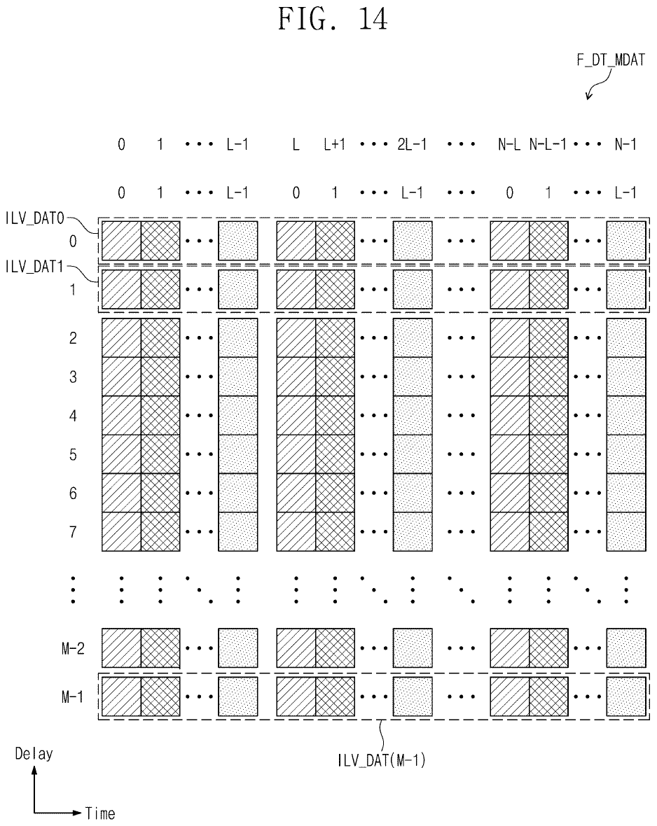

FIG. 13 is a block diagram illustrating an embodiment of the interleaver of FIG. 10.

Referring to FIG. 13, the interleaver 155 may include a plurality of interleaving circuits 155-1, 155-2, and 155-3.

The interleaving circuit 155-1 may receive the row data R_DAT0 and perform interleaving on the row data R_DAT0 to generate interleaved data ILV_DAT0. The interleaving circuit 155-2 may receive the row data R_DAT1 and perform interleaving on the row data R_DAT1 to generate the interleaved data ILV_DAT1. The interleaving circuit 155-3 may receive the row data R_DAT(M−1) and perform interleaving on the row data R_DAT(M−1) to generate the interleaved data ILV_DAT(M−1).

In an embodiment, as described above with reference to FIG. 11, the size of each of the plurality of row data R_DAT0, R_DAT1, . . . , and R_DAT (M−1) may be 1×N, and each of the plurality of interleaving circuits 155-1, 155-2 and 155-3 may perform interleaving on the corresponding row data. The interleaving performed by each of the plurality of interleaving circuits 155-1, 155-2, and 155-3 may be performed in parallel, and the interleaved data ILV_DAT0, ILV_DAT1, . . . , and ILV_DAT(M−1) may be output at substantially the same time point (or within an allowable error range).

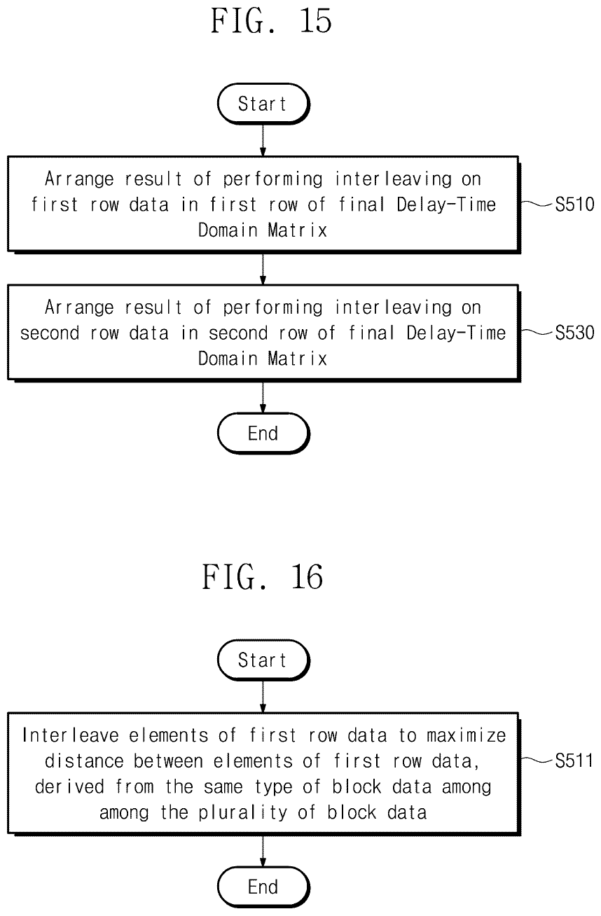

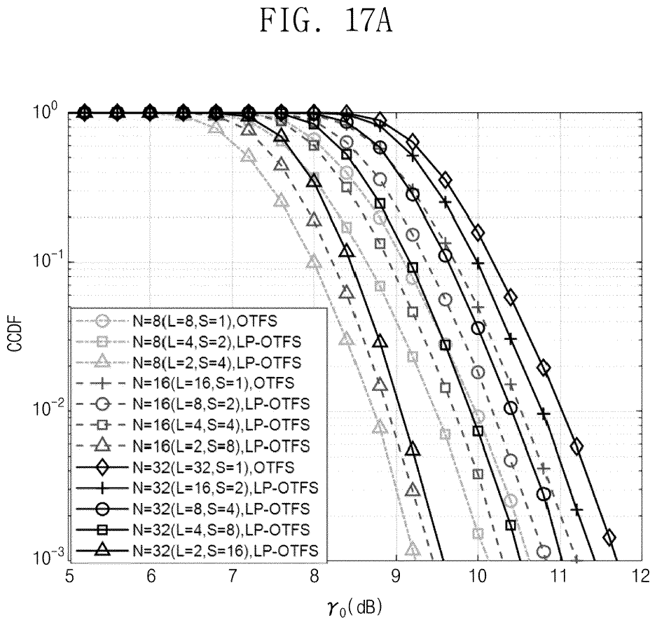

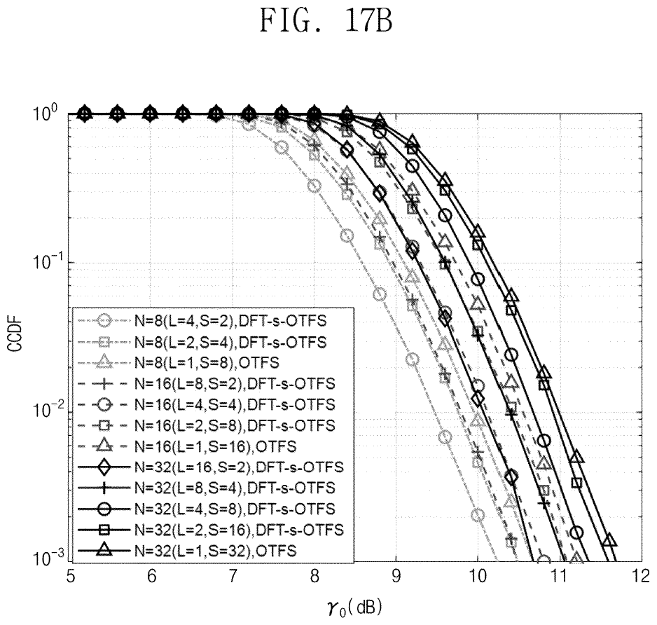

FIG. 14 is a diagram for describing an embodiment of the final delay-time domain matrix of FIG. 2. FIG. 15 is a flowchart illustrating an embodiment of the operation of generating the final delay-time domain matrix of FIG. 2. FIG. 16 is a flowchart illustrating an embodiment of an operation of interleaving the first row data of FIG. 15 to arrange the interleaved first row data in a first row of the final delay-time domain matrix.

Referring to FIG. 14, the interleaved data ILV_DAT0 may be arranged in a first row 0 of the plurality of rows 0, . . . , and (M−1) of the final delay-time domain matrix F_DT_MDAT, the interleaved data ILV_DAT1 may be arranged in a second row 1 of the plurality of rows 0, . . . , and (M−1) of the final delay-time domain matrix F_DT_MDAT, and the interleaved data ILV_DAT(M−1) may be arranged in an M-th row (M−1) of the plurality of rows 0, . . . , and (M−1) of the final delay-time domain matrix F_DT_MDAT.

In an embodiment, the interleaved data may be generated based on the corresponding row data, and a position where the interleaved data is arranged in the final delay-time domain matrix F_DT_MDAT may be the same as a position where a row data corresponding to the interleaved data is arranged in a delay-time domain matrix DT_MDAT. For example, the position where the interleaved data ILV_DAT0 is arranged in the final delay-time domain matrix F_DT_MDAT may be the same as the position where the row data R_DAT0 is arranged in the delay-time domain matrix DT_MDAT.

Referring to FIGS. 14 and 15, in the operation of generating the final delay-time domain matrix F_DT_MDAT, a result of performing interleaving on the first row data among the plurality of row data R_DAT0, R_DAT1, . . . , and R_DAT(M−1) may be arranged in a first row of the final delay-time domain matrix F_DT_MDAT (S510), and a result of performing Interleaving on a second row data among the plurality of row data R_DAT0, R_DAT1, . . . , and R_DAT(M−1) may be arranged in a second row of the final delay-time domain matrix F_DT_MDAT (S530).

Referring to FIGS. 15 and 16, in the operation of arranging the result of performing interleaving on the first row data in the first row of the final delay-time domain matrix F_DT_MDAT, elements of the first row data may be interleaved to maximize the distance between the elements of the first row data, derived from the same type of block data among the plurality of block data (S511).

FIG. 17A is a diagram illustrating a simulation result of LP-OTFS, a method of transmitting a signal in the OTFS system according to embodiments of the present disclosure, and FIG. 17B is a diagram illustrating a simulation result of signal transmission methods according to a comparative example.

In FIG. 17A and FIG. 17B, a carrier frequency for the simulation is 4 GHz, an interval Δf of the subcarriers is 15 kHz, the number of zero padding is 4, and an Extended Vehicular A (EVA) is used as a channel model for transmission and reception. In each of the delay-Doppler domain matrix DD_MDAT, the delay-time domain matrix DT_MDAT, and the final delay-time domain matrix F_DT_MDAT, the row size M was fixed to 64, and the column size N was varied to 8, 16, and 32. As the value of the N is changed, the number S of block data and the size L of each of the block data are varied (e.g., N=S×L). For example, when the N is 32, S may be changed in order of 1, 2, 4, 8, 16, and 32, and the size L of each of the block data corresponding to the N may be varied in order of 32, 16, 8, 4, 2, and 1. A modulation scheme of information symbols is 4-QAM, and a Block-wise MMSE scheme is used as an equalization scheme in reception.

Referring to FIG. 17A and FIG. 17B, a complementary cumulative distribution function (CCDF) versus PAPR (γ₀) graph is shown when the Nyquist oversampling rate of the transmission signal according to the signal transmission method LP-OTFS and the DFT-s-OTFS of the OTFS system is 4, and the N is varied to 8, 16, and 32.

Comparing FIG. 17A with FIG. 17B, it can be seen that the graphs move relatively to the left by the signal transmission method LP-OTFS, and thus the LP-OTFS has a lower PAPR compared with DFT-s-OTFS.

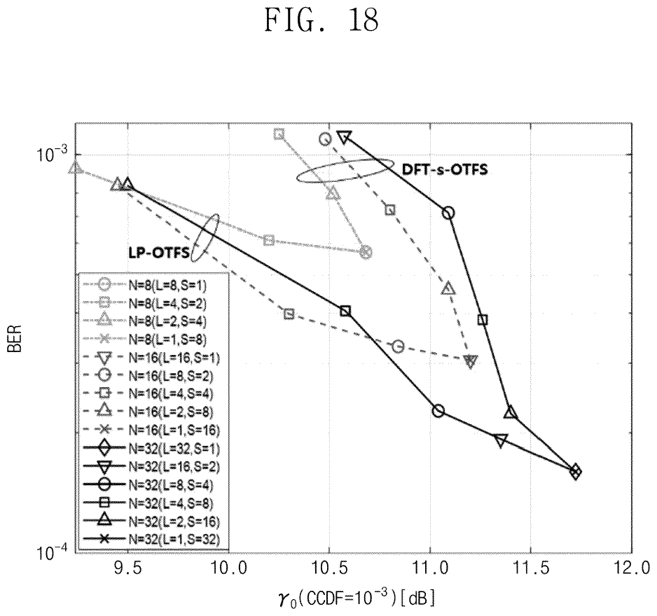

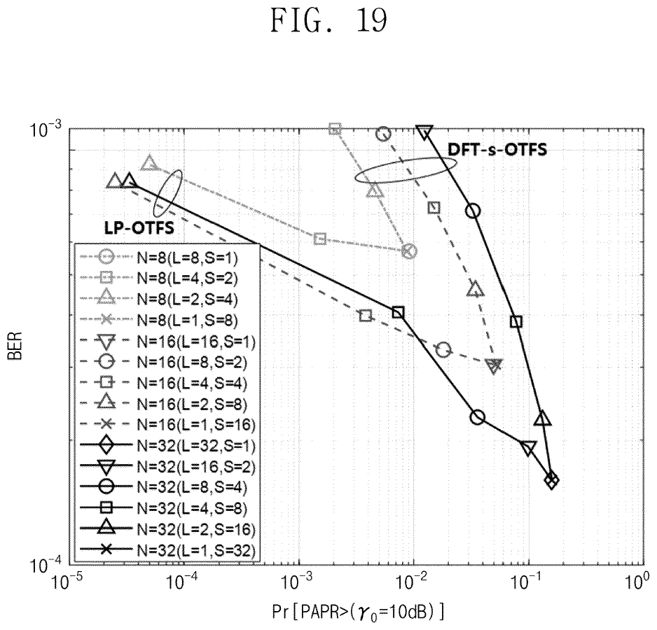

FIGS. 18 and 19 are diagrams illustrating simulation results of the LP-OTFS, the method of transmitting the signal in the OTFS system according to embodiments of the present disclosure and the signal transmission methods according to a comparative example.

In FIG. 18, the bit error rate BER is shown at a PAPR γ₀ in which the CCDF can achieve 10-3 according to variations in the N, the L, and the S in a high-speed moving environment having a speed of 300 km/h and a signal-to-noise ratio SNR of 20 dB.

Referring to FIG. 18, the bit error rate performance of the LP-OTFS is best when the L is equal to the N, while for the DFT-s-OTFS, the bit error rate performance is best when the L is 1. However, in both these cases, the PAPR is at its highest. For LP-OTFS, as the L decreases, the bit error rate performance decreases, but the PAPR also decreases. On the other hand, for DFT-s-OTFS, as the L decreases, the bit error rate performance increases, but the PAPR also increases.

In FIG. 19, a graph of bit error rate versus Pr[PAPR>(γ₀=10 dB)] is shown for both the LP-OTFS and the DFT-s-OTFS The horizontal axis represents the probability that the PAPR exceeds 10 dB (i.e., the linear operating range of the high power amplifier) in FIGS. 17A and 17B. The vertical axis of FIG. 19 is the same as that of FIG. 18.

Referring to FIG. 19, for the LP-OTFS, as the L decreases, the bit error rate performance decreases, but the Pr[PAPR>(γ₀=10 dB)] also decreases. On the other hand, for the DFT-s-OTFS, as the L decreases, the bit error rate performance increases, but Pr[PAPR>(γ₀=10 dB)] also increases.

Referring to FIGS. 18 and 19, it can be seen that the performance of the LP-OTFS according to the embodiments of the present disclosure is generally better than that of the DFT-s-OTFS. For example, when N is 16, the lowest PAPR for the LP-OTFS occurs when L=2, S=8, and the lowest PAPR for the DFT-s-OTFS occurs when L=8, S=2.

Referring to FIG. 18, for the LP-OTFS and the DFT-s-OTFS, the “PAPR (γ₀) value attaining CCDF=10-3” is 9.45 dB and 10.48 dB, respectively.

Referring to FIG. 19, Pr[PAPR>((γ₀=10 dB)] values of the signal transmission method LP-OTFS and the DFT-s-OTFS are 2.5×10−5 and 5.4×10−3, respectively.

As a result, comparing the horizontal axes of FIG. 18 and FIG. 19, it can be seen that the PAPR of the LP-OTFS is much lower than that of the DFT-s-OTFS. In addition, comparing the vertical axes of FIG. 18 and FIG. 19, the bit error rates of the LP-OTFS and the DFT-s-OTFS are 8.34×10−4 and 1.1×10−3, respectively, so that it can be seen that the LP-OTFS is superior to the DFT-s-OTFS.

On the other hand, the transmission computational complexity between the LP-OTFS and the DFT-s-OTFS may be compared based on the number of complex multiplications performed in each.

The transmission computational complexity of the DFT-s-OTFS is O(MN(log₂LN)). In this case, computational complexity according to DFT precoding was considered.

The transmission computational complexity of the LP-OTFS is O(MNlog₂N). Since the L-point IDFT is performed on the S block data in the conversion from the delay-Doppler domain to the delay-time domain, the transmission computational complexity becomes O(MNlog₂N).

In an embodiment, a signal reception apparatus corresponding to the signal transmission apparatus of FIG. 1 may be implemented. The signal reception apparatus may generate information symbols by performing DFT and deinterleaving corresponding to IDFT and interleaving according to embodiments of the present disclosure on a signal received through a channel.

As described above, a signal transmission apparatus of an OTFS system according to embodiments of the present disclosure may perform IDFT on each of a plurality of block data obtained by grouping elements of a delay-Doppler domain matrix to generate a delay-time domain matrix, and may interleave each of the plurality of row data obtained by grouping elements of the delay-time domain matrix to generate a final delay-time domain matrix. The signal transmission apparatus may perform only IDFT on each of a plurality of block data and interleaving of each of the plurality of row data as main operations for transmitting the signal, and may significantly improve BER, reduce PAPR, and significantly reduce transmission complexity.

The foregoing is specific embodiments for practicing the present disclosure. The present disclosure will include not only the above-described embodiments, but also embodiments that can be simply changed in design or easily changed. In addition, the present disclosure will include techniques that can be easily modified and implemented by using embodiments. Therefore, the scope of the present disclosure should not be limited to the above-described embodiments, but should be defined by the following claims as well as those equivalent to the claims of the present disclosure.

What is claimed is:

1. A method of transmitting a signal in an orthogonal time frequency space (OTFS) system, the method comprising:
generating a delay-Doppler domain matrix based on information symbols;
generating a plurality of block data by grouping elements of the delay-Doppler domain matrix;
generating a delay-time domain matrix by performing an Inverse Discrete Fourier Transform (IDFT) on each of the plurality of block data;
generating a plurality of row data by grouping elements of the delay-time domain matrix;
generating a final delay-time domain matrix by interleaving each of the plurality of row data; and
transmitting a transmission signal based on the final delay-time domain matrix.

2. The method of claim 1, wherein the generating the plurality of block data includes:
generating each of the plurality of block data based on a result of grouping the elements of the delay-Doppler domain matrix along a Doppler axis of the delay-Doppler domain.

3. The method of claim 1, wherein the generating the plurality of row data includes:
generating each of the plurality of row data based on a result of grouping the elements of the delay-time domain matrix along a delay axis of the delay-time domain.

4. The method of claim 1, wherein the generating the plurality of block data includes:
generating first block data of the plurality of block data by grouping elements arranged in first columns of a plurality of columns of the delay-Doppler domain matrix; and
generating second block data of the plurality of block data by grouping elements arranged in second columns of the plurality of columns of the delay-Doppler domain matrix.

5. The method of claim 4, wherein:
a plurality of rows of the delay-Doppler domain matrix corresponds to a delay axis of the delay-Doppler domain; and
the plurality of columns of the delay-Doppler domain matrix correspond to a Doppler axis of the delay-Doppler domain.

6. The method of claim 4, wherein the generating the plurality of row data comprises:
generating first row data of the plurality of row data by grouping elements arranged in a first row of the plurality of rows of the delay-time domain matrix; and
generating second row data of the plurality of row data by grouping elements arranged in a second row of the plurality of rows of the delay-time domain matrix.

7. The method of claim 6, wherein:
the plurality of rows of the delay-time domain matrix correspond to a delay axis of a delay-time domain; and
the plurality of columns of the delay-time domain matrix correspond to a time axis of the delay-time domain.

8. The method of claim 1, wherein the generating the delay-time domain matrix includes:
arranging a result of performing the IDFT on first block data of the plurality of block data in a first block of the delay-time domain matrix; and
arranging a result of performing the IDFT on second block data of the plurality of block data in the second block of the delay-time domain matrix.

9. The method of claim 8, wherein the generating the final delay-time domain matrix includes:
arranging a result of performing interleaving on first row data of the plurality of row data in a first row of the final delay-time domain matrix; and
arranging a result of performing interleaving on second row data of the plurality of row data in a second row of the final delay-time domain matrix.

10. The method of claim 9, wherein the arranging the result of performing interleaving on the first row data of the plurality of row data in the first row of the final delay-time domain matrix includes:
interleaving the elements of the first row data to maximize a distance between the elements of the first row data, derived from a same type of block data of the plurality of block data.

11. The method of claim 1, wherein a size of the delay-Doppler domain matrix, a size of the delay-time domain matrix, and a size of the final delay-time domain matrix are equal to each other.

12. The method of claim 1, wherein:
a size of the delay-Doppler domain matrix is M×N (M, N are an integer greater than or equal to two);
a size of each of the plurality of block data is M×L (L is an integer greater than or equal to one); and
the L is less than the N.

13. The method of claim 12, wherein:
a number of the plurality of block data is S (S is an integer greater than or equal to two), and
the L is a value obtained by dividing the N by the S.

14. The method of claim 1, wherein the transmitting the transmission signal includes:
performing a Heisenberg transform based on the final delay-time domain matrix.

15. An apparatus of transmitting a signal in an OTFS system, the apparatus comprising:
a delay-Doppler domain matrix generator configured to generate a delay-Doppler domain matrix based on information symbols;
a delay-time domain matrix generator configured to generate a delay-time domain matrix based on a plurality of block data obtained by grouping elements of the delay-Doppler domain matrix;
a final delay-time domain matrix generator configured to generate a final delay-time domain matrix based on a plurality of row data obtained by grouping elements of the delay-time domain matrix; and
a transmitter configured to transmit a transmission signal based on the final delay-time domain matrix.

16. The apparatus of claim 15, wherein the delay-time domain matrix generator is configured to perform IDFT on each of the plurality of block data.

17. The apparatus of claim 16, wherein the final delay-time domain matrix generator is configured to interleave each of the plurality of row data.

18. The apparatus of claim 17, wherein:
the delay-time domain matrix generator is configured to generate each of the plurality of block data based on grouping elements of the delay-Doppler domain matrix along a Doppler axis of the delay-Doppler domain; and
the final delay-time domain matrix generator is configured to generate each of the plurality of row data based on grouping elements of the delay-time domain matrix along a delay axis of a delay-time domain.

19. The apparatus of claim 15, wherein the delay-time domain matrix generator is configured to perform IDFT on first block data of the plurality of block data to arrange a result of the IDFT on the first block data in a first block of the delay-time domain matrix.

20. The apparatus of claim 19, wherein the final delay-time domain matrix generator is configured to interleave first row data of the plurality of row data to arrange the interleaved first row data in a first row of the final delay-time domain matrix.
